(19) United States
(12) Patent Application Publication
(10) Pub. No.: US 2025/0116362 A1
(43) Pub. Date: Apr. 10, 2025

(54) QUICK CONNECTOR

(71) Applicant: CHIA CHERNE INDUSTRY CO., LTD., Chang Hwa City (TW)

(72) Inventor: Tsung-Ping CHIU, Chang Hwa (TW)

(21) Appl. No.: 18/480,942

(22) Filed: Oct. 4, 2023

(51) Int. Cl. F16L 37/12

(52) U.S. Cl. CPC F16L 37/1225

(57) ABSTRACT

A quick connector includes a first connector, a second connector, a pressing fastener and a push rod. The first connector is provided with a first pipe body, an annular groove concavely arranged on the first pipe body, and a first flow channel axially passing through the first pipe body. The second connector includes a second pipe body and a second flow channel axially passing through the second pipe body for the first pipe body to insert. When the pressing fastener and a pressing spring is pressed, the first connector and the second connector are in a separable state, the push rod is configured to push the first connector to separate from the second connector. When the first pipe body is inserted into the second flow channel, the pressing fastener is changed from an unlocking position to a locking position, and the first connector and the second connector are connected.

### FIELD OF THE INVENTION

The present invention relates to a pipeline connector, and particularly to a quick connector.

### BACKGROUND OF THE INVENTION

A liquid cooling system has a good heat dissipating effect, which can effectively increase maximal operating power of an electronic component, and is already widely used in high-efficient electronic components. A heat exchanging medium of the liquid cooling system is cooling fluid with high specific heat, which can quickly take away heat to quickly cool down by means of the characteristics of rapid heat conduction of the cooling fluid.

In order to meet pipeline configuration requirements of various systems, the liquid cooling system may be provided with a plurality of fluid pipelines, and different fluid pipelines need to be assembled and disassembled by using pipeline connectors so as to meet the needs of cleaning, repair and maintenance. Conventional pipeline connectors are connected in a screw locking manner, which has the problem of difficult operation in a narrow space.

Therefore, for example, a quick connector disclosed in American Publication No. US 2023/0213128 A1 can be quickly connected or separated, but there is no lock design, and once the pipeline is pulled, the pipeline may be separated.

For another example, a quick coupler assembly disclosed in American Publication No. U.S. Pat. No. 10,801,655 B2 is provided with a quick release locking sleeve, which is used for controlling the joint or separation. However, in order to avoid pulling the pipeline, the quick release structure needs to be operated by both hands to make the quick release locking sleeve slip so as to control the joint or separation, so that the operation is still inconvenient.

### SUMMARY OF THE INVENTION

A main purpose of the present invention is to disclose a quick connector which can be disassembled by a single hand, so as to improve the practicability of products.

In order to achieve the above purpose, the present invention discloses a quick connector, which includes a first connector, a second connector, a pressing fastener, and a push rod, where the first connector is provided with a first pipe body, an annular groove and a first flow channel, the annular groove is concavely arranged in an outer edge of the first pipe body, and the first flow channel axially passes through the first pipe body. The second connector includes a second pipe body and a second flow channel, the second flow channel axially passes through the second pipe body and is used for the first pipe body to insert, where the second pipe body is provided with a transverse chute and an axial chute, the transverse chute transversely passes through the second pipe body and extends into the second flow channel, and an opening of the axial chute faces the first connector and is parallel to an axial direction of the second pipe body.

The pressing fastener is slidable to be arranged in the transverse chute and is provided with a locking position and an unlocking position on the transverse chute; a pressing spring is arranged between the pressing fastener and the second pipe body; the pressing spring pushes the pressing fastener to move from the unlocking position to the locking position; the pressing fastener is provided with an open pore, a clamping portion and a slot; the open pore is provided for the first pipe body to pass through; the clamping portion is adjacent to the open pore; and the slot is connected with the open pore, and a slot width of the slot is gradually reduced towards an end of the slot along a moving direction of the pressing fastener relative to the transverse chute. When the pressing fastener is in the locking position, the clamping portion extends into the second flow channel and is clamped into the annular groove to fix the first pipe body, so that the first connector and the second connector are in a joined state. When the pressing fastener is in the unlocking position, the open pore is opposite to the second flow channel and is provided for the first pipe body to pass through, so that the first connector and the second connector are in a separable state.

The push rod is provided with a top, a bottom and a neck, where the neck is disposed between the top and the bottom; a length of the neck is greater than a thickness of the pressing fastener, and the neck is provided with a first neck surface and a second neck surface; the first neck surface is connected with the top, and the second neck surface is connected with the bottom; a thickness of the first neck surface is less than the thickness of the second neck surface; the bottom of the push rod is slidable to be arranged in the axial chute with a pushing spring in between; the neck is clamped into the slot and is limited to slide on the slot; when the pressing fastener is in the locking position, a slot width of the slot align to the neck is between the thickness of the first neck surface and the thickness of the second neck surface; when the pressing fastener is in the unlocking position, the slot width of the slot align to the neck is greater than the thickness of the second neck surface; when the pressing fastener is changed from the locking position to the unlocking position, the second neck surface penetrates into the slot; the pushing spring pushes the push rod, and the top pushes the first connector, so that the first connector is separated from the second connector; when the first pipe body is inserted into the second flow channel, the first connector pushes the top of the push rod, so that the second neck surface is separated from the slot, the first neck surface enters the slot, and the pressing fastener is changed from the unlocking position to the locking position through the pressing spring; and the clamping portion is clamped into the annular groove to fix the first pipe body, so that the first connector and the second connector are joined.

Accordingly, by designing the pressing fastener and the push rod, as long as the pressing fastener is pressed, the pressing fastener is changed from the locking position to the unlocking position, the top of the push rod pushes the first connector, so that the first connector can be separated from the second connector by a single-hand operation, which can meet the operational requirements.

### BRIEF DESCRIPTION OF THE DRAWINGS

FIG. 1 is a schematic diagram of an overall structure of the present invention.

FIG. 2 is a schematic diagram of an exploded structure of the present invention.

FIG. 3 is a sectional view of the present invention in a joined state.

FIG. 4 is a sectional view of a separation action of the present invention.

FIG. 5 is a sectional view of a joint action of the present invention.

### DETAILED DESCRIPTION OF THE PREFERRED EMBODIMENTS

The detailed description and technical content of the present invention are described below with reference to the accompanying drawings.

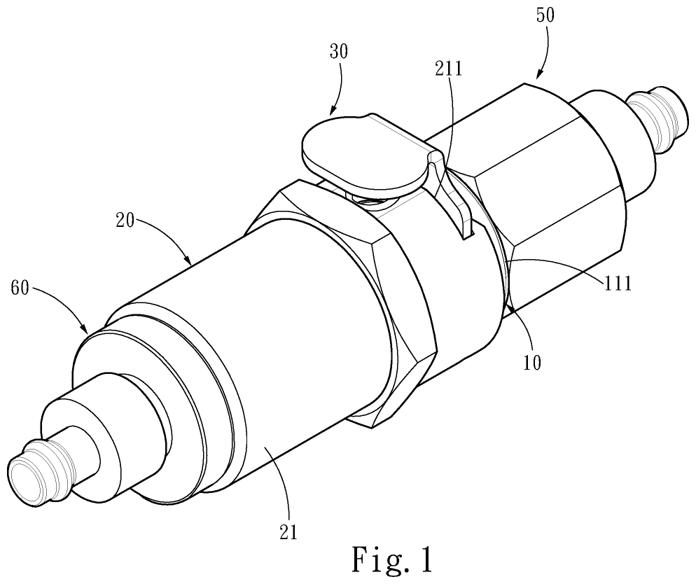

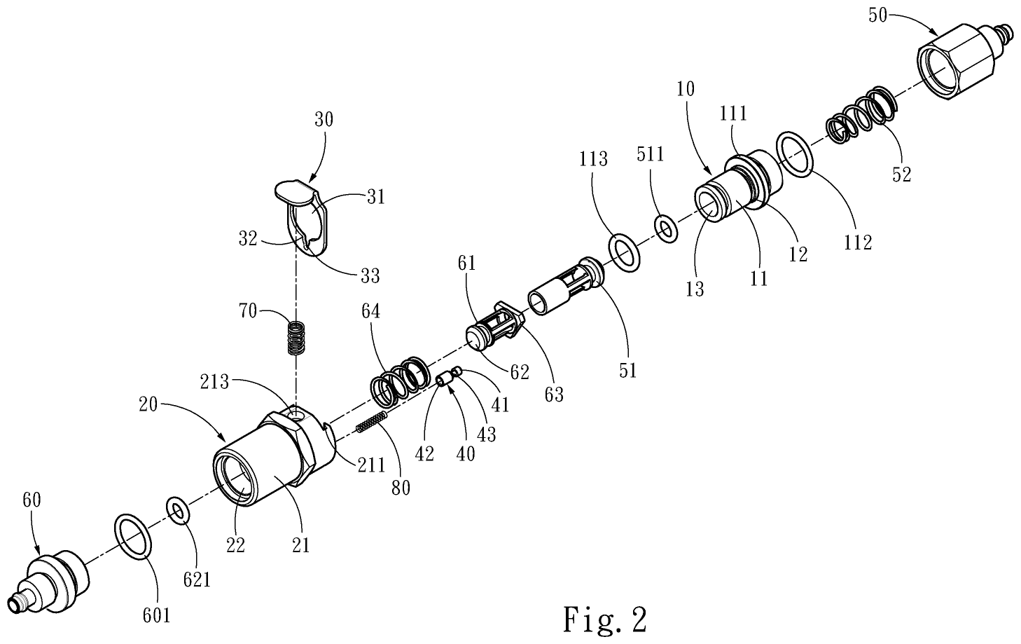

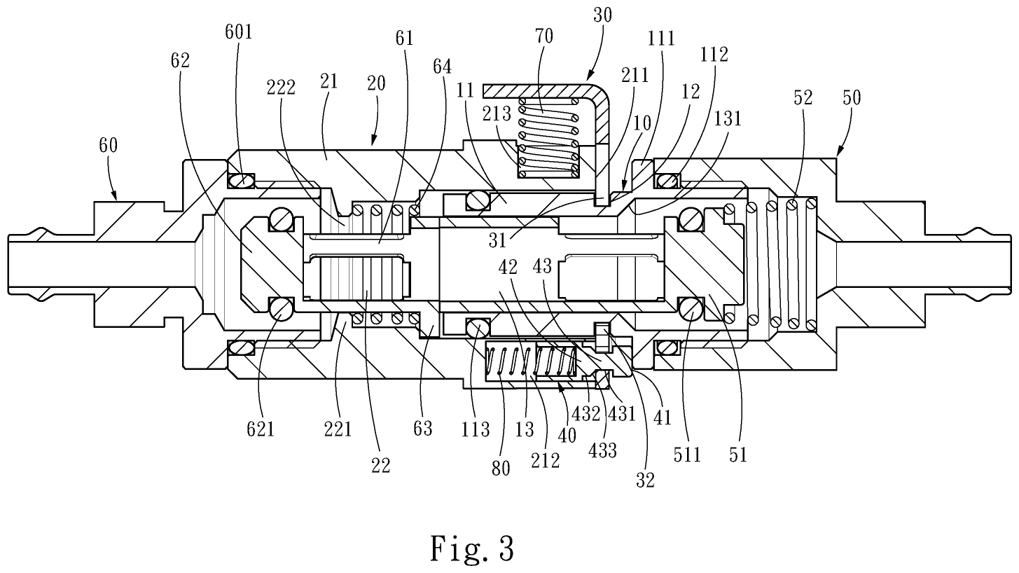

Referring to FIG. 1, FIG. 2, and FIG. 3, the present invention discloses a quick connector including a first connector 10, a second connector 20, a pressing fastener 30, and a push rod 40, wherein the first connector 10 is provided with a first pipe body 11, an annular groove 12 and a first flow channel 13, the annular groove 12 is concavely arranged in an outer edge of the first pipe body 11, and the first flow channel 13 axially passes through the first pipe body 11. In an embodiment, the first pipe body 11 is locked to a first pipe connector 50. As shown in FIG. 3, the first flow channel 13 is provided with a conical inner annular surface 131 and a first plug body 51; a first spring 52 is arranged between the first plug body 51 in and the first pipe connector 50, one end of the first spring 52 pushes against the first pipe connector 50, and the other end of the first spring 52 pushes the first plug body 51 to abut the conical inner annular surface 131 so as to seal the first flow channel 13; and particularly, in FIG. 3, the first plug body 51 does not seal the first flow channel 13, and the first spring 52 is in a compressed state.

In an embodiment, the first plug body 51 is provided with an O-ring 511; and the first plug body 51 contacts the conical inner annular surface 131 without a gap through the O-ring 511, so that a liquid-sealing structure is formed to seal the first flow channel 13. The first pipe body 11 is provided with an outer annular flange 111; the outer annular flange 111 clamps the first pipe connector 50 to limit a locking depth between the first pipe body 11 and the first pipe connector 50 so as to avoid fracture caused by an excessive locking. The first pipe body 11 is provided with an O-ring 112 near the outer annular flange 111; the O-ring 112 contacts an inner edge of the first pipe connector 50 without a gap; and the first pipe body 11 and the first pipe connector 50 form a liquid-sealing structure.

The second connector 20 includes a second pipe body 21 and a second flow channel 22; the second flow channel 22 axially passes through the second pipe body 21; the second flow channel 22 is used for inserting and accommodating the first pipe body 11; the first pipe body 11 is also provided with an O-ring 113 corresponding to the second flow channel 22; and the O-ring 113 contacts the second flow channel 22 without a gap, and forms a liquid-sealing structure between the first pipe body 11 and the second pipe body 21.

As shown in FIG. 3, the second pipe body 21 is provided with a transverse chute 211 and an axial chute 212, the transverse chute 211 transversely passes through the second pipe body 21 and extends into the second flow channel 22, and an opening of the axial chute 212 faces the first connector 10 and is parallel to an axial direction of the second pipe body 21.

In an embodiment, the second connector 20 is locked by a second pipe connector 60; the second flow channel 22 is provided with an protruding annular wall 221 protruding toward an axis center and provided with a second plug body 61; a passage 222 is formed at a center of the protruding annular wall 221; the second plug body 61 passes through the passage 222 and forms a chock plug 62 and a wing plate 63 at two sides of the passage 222; a second spring 64 is arranged between the wing plate 63 and the protruding annular wall 221; and one end of the second spring 64 pushes against the protruding annular wall 221, and the other end of the second spring 64 pushes the wing plate 63 so as to drive the chock plug 62 to contact the protruding annular wall 221, thereby sealing the second flow channel 22.

In an embodiment, the chock plug 62 is provided with an O-ring 621; the chock plug 62 contacts the protruding annular wall 221 without a gap through the O-ring 621 to form a liquid-sealing structure to seal the passage 222. Particularly, in FIG. 3, the chock plug 62 does not close the passage 222, and the second spring 64 is in a compressed state. In an embodiment, the second pipe connector 60 is provided with an O-ring 601; the O-ring 601 contacts the second pipe body 21 without a gap, and a liquid-sealing structure is formed between the second pipe body 21 and the second pipe connector 60.

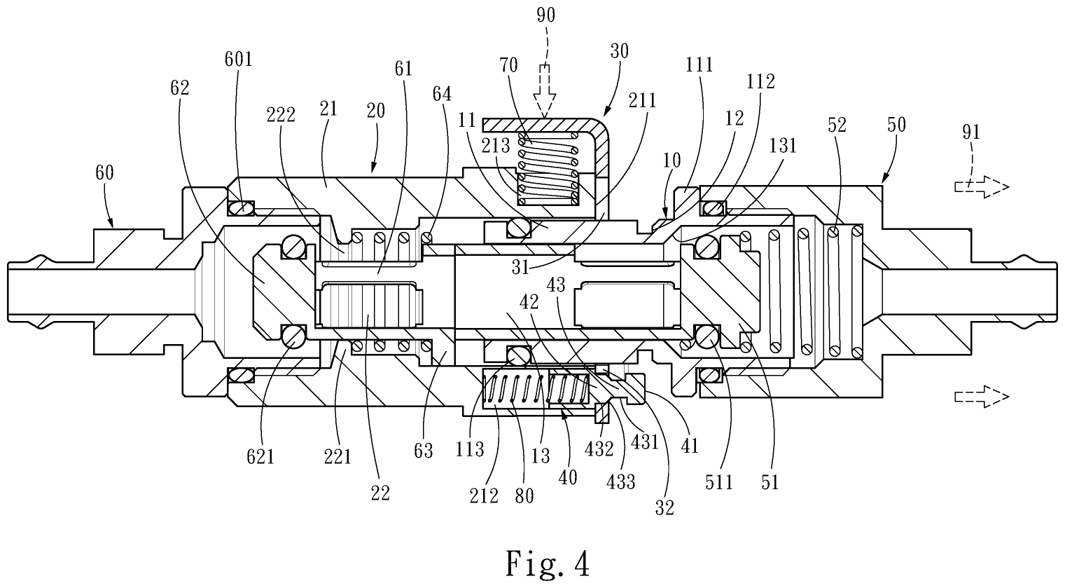

Referring to FIG. 3 and FIG. 4, the pressing fastener 30 is slidable to be arranged in the transverse chute 211, and is provided with a locking position (as shown in FIG. 3) and an unlocking position (as shown in FIG. 4) in the transverse chute 211; a pressing spring 70 is arranged between the pressing fastener 30 and the second pipe body 21; and the pressing spring 70 pushes the pressing fastener 30 to move from the unlocking position to the locking position. In an embodiment, the second pipe body 21 is provided with a recess 213 for accommodating the pressing spring 70.

The pressing fastener 30 is provided with an open pore 31, a clamping portion 32 and a slot 33; the open pore 31 is provided for the first pipe body 11 to pass through; the clamping portion 32 is adjacent to the open pore 31; the slot 33 is connected with the open pore 31, and a slot width of the slot 33 is gradually reduced to an end of the slot 33 along a moving direction of the pressing fastener 30 relative to the transverse chute 211. When the pressing fastener 30 is in the locking position, the clamping portion 32 extends into the second flow channel 22 and is clamped into the annular groove 12 to fix the first pipe body 11 (as shown in FIG. 3), so that the first connector 10 and the second connector 20 are in a joined state.

The push rod 40 is provided with a top 41, a bottom 42 and a neck 43; the neck 43 is disposed between the top 41 and the bottom 42. A length of the neck 43 is greater than a thickness of the pressing fastener 30. The neck 43 is provided with a first neck surface 431 and a second neck surface 432. A diameter of the first neck surface 431 is less than a diameter of the second neck surface 432. The first neck surface 431 is connected with the top 41; the second neck surface 432 is connected with the bottom 42; and preferably, the first neck surface 431 and the second neck surface 432 are connected through a connecting slope 433.

The bottom 42 of the push rod 40 is sliceable disposed in the axial chute 212 with a pushing spring 80 arranged therebetween. The neck 43 is clamped into the slot 33 and limited to slide in the slot 33. When the pressing fastener 30 is in the locking position, the slot width of the slot 33 aligned to the neck 43 is between the diameter of the first neck surface 431 and the diameter of the second neck surface 432; and when the pressing fastener 30 is in the unlocking position, the slot width of the slot 33 aligned to the neck 43 is greater than the diameter of the second neck surface 432.

With the above structure, when the pressing fastener 30 is in the locking position, the second neck surface 432 cannot penetrate into the slot 33 (as shown in FIG. 3); and when an operator presses the pressing fastener 30 along a first direction 90, the pressing fastener 30 is slided relative to the transverse chute 211, so that the pressing fastener 30 is changed from the locking position to the unlocking position.

When the pressing fastener 30 is in the unlocking position, the open pore 31 is aligned to the second flow channel 22 and provided for the first pipe body 11 to pass through, that is, the clamping portion 32 is not clamped into the annular groove 12 at the time (as shown in FIG. 4), and the first connector 10 and the second connector 20 are in a separable state; and at the same time, the second neck surface 432 can penetrate into the slot 33, the pushing spring 80 pushes the push rod 40, and the top 41 pushes the first connector 10 to be popped out and separated from the second connector 20 along a second direction 91 (as shown in FIG. 4).

That is, the operator can separate the first connector 10 from the second connector 20 by pressing the pressing fastener 30 with one hand. The operator can complete the disassembling without both hands, so that the operational requirements can be met.

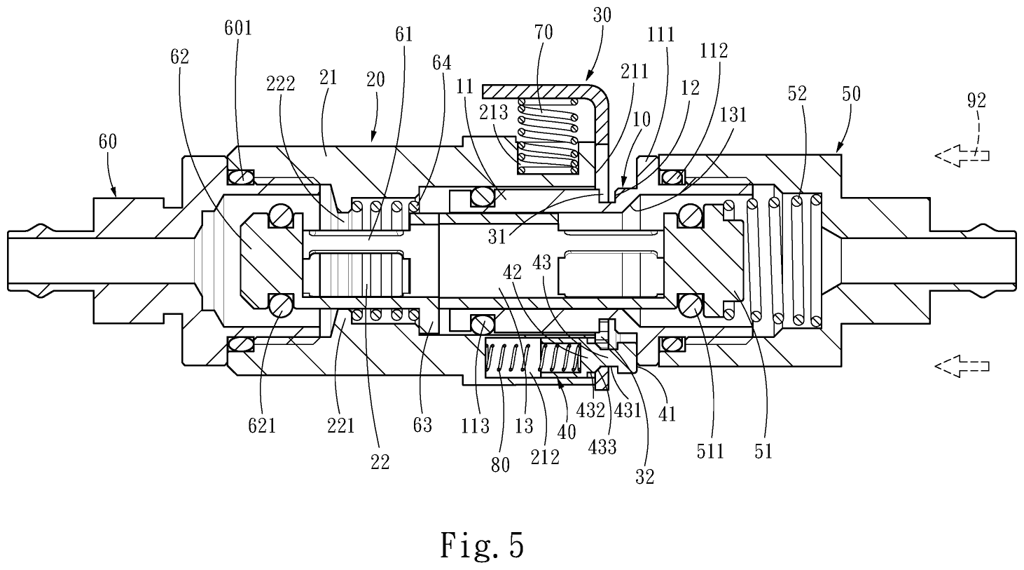

Referring to FIG. 5, when the first connector 10 and the second connector 20 need to be joined, as long as the first pipe body 11 is inserted into the second flow channel 22 along a third direction 92, the first connector 10 pushes the top 41 of the push rod 40, so that the second neck surface 432 can be separated from the slot 33 (as shown in FIG. 5), the first neck surface 431 re-enters the slot 33 (as shown in FIG. 3), and at the time, the pressing fastener 30 is changed from the unlocking position to the locking position through the pressing spring 70; and the clamping portion 32 is clamped into the annular groove 12 to fix the first pipe body 11, so that the first connector 10 and the second connector 20 are joined.

As mentioned above, the present invention has the characteristics as follows:
1. The pressing fastener can be pressed by one hand to be changed from the locking position to the unlocking position; and at the same time, the top may push the first connector, so that the first connector can be separated from the second connector by the single-hand operation, and the operational requirements can be met.
2. As long as the first pipe body is inserted into the second flow channel, the first connector may push the top of the push rod to make the first neck surface re-enter the slot, so that the pressing fastener can be changed from the unlocking position to the locking position through an elastic force of the pressing spring, and the clamping portion is clamped into the annular groove, and the first connector and the second connector are rejoined.
3. By designing the first plug body and the second plug body, after the first connector is separated from the second connector, the first flow channel and the second flow channel can be closed, so that the leakage of fluid in the first flow channel and the second flow channel can be avoided, and the operational convenience can be improved.

What is claimed is:

1. A quick connector, comprising:
a first connector, the first connector comprising a first pipe body, an annular groove concavely arranged in an outer edge of the first pipe body, and a first flow channel axially passing through the first pipe body;
a second connector, the second connector comprising a second pipe body, and a second flow channel axially passing through the second pipe body and provided for the first pipe body to insert, wherein the second pipe body is provided with a transverse chute transversely passing through the second pipe body and extending into the second flow channel, and an axial chute with an opening facing the first connector and parallel to an axial direction of the second pipe body;
a pressing fastener, the pressing fastener being slidable to be arranged in the transverse chute and being provided with a locking position and an unlocking position on the transverse chute, a pressing spring being arranged between the pressing fastener and the second pipe body, the pressing spring pushing the pressing fastener to move from the unlocking position to the locking position, the pressing fastener being provided with an open pore for the first pipe body to pass through, a clamping portion adjacent to the open pore, and a slot connected with the open pore, a slot width of the slot being gradually reduced to an end of the slot along a moving direction of the pressing fastener relative to the transverse chute, wherein when the pressing fastener is in the locking position, the clamping portion extends into the second flow channel and is clamped into the annular groove to fix the first pipe body, the first connector and the second connector are in a joined state; and when the pressing fastener is in the unlocking position, the open pore is aligned to the second flow channel and is provided for the first pipe body to pass through, the first connector and the second connector are in a separable state; and
a push rod, the push rod comprising a top, a bottom and a neck disposed between the top and the bottom, a length of the neck being greater than a thickness of the pressing fastener, the neck being provided with a first neck surface connected with the top and a second neck surface connected with the bottom, a diameter of the first neck surface being smaller than a diameter of the second neck surface, the bottom of the push rod being slidable to be arranged in the axial chute with a pushing spring therebetween, the neck being clamped into the slot and limited to slide on the slot, wherein when the pressing fastener is in the locking position, the slot width of the slot aligned to the neck is between the diameter of the first neck surface and the diameter of the second neck surface, when the pressing fastener is in the unlocking position, the slot width of the slot aligned to the neck is greater than the diameter of the second neck surface, when the pressing fastener is changed from the locking position to the unlocking position, the second neck surface penetrates into the slot, and the pushing spring pushes the push rod, and the top pushes the first connector, and the first connector is separated from the second connector; when the first pipe body is inserted into the second flow channel, the first connector pushes the top of the push rod, and the second neck surface is separated from the slot, the first neck surface enters the slot, and the pressing fastener is changed from the unlocking position to the locking position through the pressing spring, and the clamping portion is clamped into the annular groove to fix the first pipe body.

2. The quick connector according to claim 1, wherein the first pipe body is locked to a first pipe connector, the first flow channel is provided with a conical inner annular surface and provided with a first plug body, a first spring is arranged between the first plug body and the first pipe connector, one end of the first spring pushes against the first pipe connector, and an other end of the first spring pushes the first plug body to abut the conical inner annular surface so as to seal the first flow channel.

3. The quick connector according to claim 2, wherein the first plug body is provided with an O-ring contacting the conical inner annular surface.

4. The quick connector according to claim 2, wherein the first pipe body is provided with an outer annular flange, and the outer annular flange clamps the first pipe connector so as to limit a locking depth between the first pipe body and the first pipe connector.

5. The quick connector according to claim 4, wherein the first pipe body is provided with an O-ring contacting the first pipe body near the outer annular flange.

6. The quick connector according to claim 1, wherein the first pipe body is provided with an O-ring contacting the second flow channel at a position corresponding to the second flow channel.

7. The quick connector according to claim 1, wherein the second connector is locked by a second pipe connector, the second flow channel is provided with an protruding annular wall protruding toward an axis center and is provided with a second plug body, a passage is formed at a center of the protruding annular wall, the second plug body passes through the passage and forms a chock plug and a wing plate at two sides of the passage, a second spring is arranged between the wing plate and the protruding annular wall, one end of the second spring pushes against the protruding annular wall, and an other end of the second spring pushes the wing plate to drive the chock plug to contact the protruding annular wall so as to seal the second flow channel.

8. The quick connector according to claim 7, wherein the chock plug is provided with an O-ring contacting the protruding annular wall.

9. The quick connector according to claim 7, wherein the second pipe connector is provided with an O-ring contacting the second pipe body.

10. The quick connector according to claim 1, wherein the second pipe body is provided with a recess for accommodating the pressing spring.
